(19) United States
(12) Patent Application Publication
(10) Pub. No.: US 2004/0117482 A1
(43) Pub. Date: Jun. 17, 2004

(54) Method, system, and program product for customizing an application

(75) Inventor: Fernando J. Salazar, Arlington, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/320,999

(22) Filed: Dec. 17, 2002

(51) Int. Cl. G06F 15/173

(52) U.S. Cl. 709/225

(57) ABSTRACT

The invention present allows customizations to be performed in an application to be based on one or more user properties. Specifically, a user is matched with a property string that is based on a user property. Using the property string, a customization object is accessed and implemented. This provides increased flexibility and automation in customizing applications for users and/or groups of users.

### BACKGROUND OF THE INVENTION

1. Technical Field

The invention generally relates to a method, system and program product for customizing computer applications. Specifically, the invention provides the ability to customize an application based on one or more user properties.

2. Background Art

As the use of computer technology becomes more pervasive, applications are being deployed with increasing frequency. Many applications provide certain behavior (i.e., functionality, user interface, etc.) regardless of the user executing the application. This presents a problem, for example, when a user should have only limited access to functionality provided by the application, and/or when different user interfaces are appropriate for various users or groups of users. To address this problem, multiple applications must be provided or a single application must be capable of being customized. The former is an expensive and inefficient way to address the issue of application customization.

With respect to the latter, some existing systems attempt to customize applications by using user “profiles.” A user profile is an explicit listing of customizations to be applied to a user. Such customizations can include things such as accessible functionality, a particular user interface, etc. With this approach, a new user is provided with a default profile that then must be customized by the user and/or an administrator. As a result, some interaction is required to properly generate user customizations. This is especially tedious when the users and/or their roles change. Specifically, when users and/or roles change, the user profiles must be updated. This can require dedication of a large amount of time and resources especially in larger organizations.

In view of the foregoing, there exists a need for a method, system, and program product for customizing an application customization based on a user property.

### SUMMARY OF THE INVENTION

The present invention provides a method, system, and program product for customizing an application. Specifically, the present invention allows the various features/traits (e.g., functionality, user interface(s), etc.) of an application to be customized based on a user property. In a typical embodiment, each customization is associated with one or more “property strings.” A property string is based on one or more user properties associated with user(s) of the system. Specifically, a property string corresponds to a set (e.g., one or more) of users. The user property used to define the string can be any way of identifying the one or more users in the set. For example, the user property can be a specific directory expression/path in a hierarchy in which the user(s) are listed, a group designation of the user(s), an attribute of the user(s), etc. In any event, the property string is associated with a customization object that defines precisely how to customize the application for that user. When an authorized user accesses the application, the user is matched with his/her corresponding property string (e.g., based on log-in information). Upon being matched, the customization object associated with the property string is accessed, assigned to the user, and used to customize the application. Thus, the present invention provides a more flexible implementation that requires less human interaction to implement application customizations.

A first aspect of the invention provides a method for customizing an application, comprising: identifying a user having a user property; matching the user with a property string that is based on the user property, wherein the property string is associated with a customization object; accessing the customization object; and customizing the application for the user based on the customization object.

A second aspect of the invention provides a method for customizing an application comprising: providing a property string that is based on a user property, wherein the property string is associated with a customization object; matching a user with the property string when the application is accessed; assigning the customization object to the user; and customizing the application based on the customization object.

A third aspect of the invention provides a system for customizing an application, comprising: an evaluation system for matching a user with a property string, wherein the property string is based on a user property; and a customization system for customizing an application for the user based on a customization object associated with the property string.

A fourth aspect of the invention provides a computer program product comprising a computer useable medium having computer readable program code embodied therein for customizing an application, the program product comprising: program code configured to match a user with a property string, wherein the property string is based on a user property; and program code configured to customize an application for the user based on a customization object associated with the property string.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various embodiments of the invention taken in conjunction with the accompanying drawings in which:

FIG. 1 depicts an illustrative system implementing the invention;

FIG. 2 depicts a detailed portion of a system according to another embodiment of the invention;

FIG. 3 depicts illustrative steps performed according to yet another embodiment of the invention;

FIG. 4A depicts an illustrative directory tree;

FIG. 4B depicts illustrative embodiments of data objects used in the invention; and

FIG. 5 depicts the system of FIG. 1 implemented in a computing environment.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The present invention provides a method, system, and program product for customizing an application. Specifically, the present invention allows the various features/traits (e.g., functionality, user interface(s), etc.) of an application to be customized based on a user property. In a typical embodiment, each customization is associated with one or more “property strings.” A property string is based on one or more user properties associated with user(s) of the system. Specifically, a property string corresponds to a set (e.g., one or more) of users. The user property used to define the string can be any way of identifying the one or more users in the set. For example, the user property can be a specific directory expression/path in a hierarchy in which the user(s) are listed, a group designation of the user(s), an attribute of the user(s), etc. In any event, the property string is associated with a customization object that defines precisely how to customize the application for that user. When an authorized user accesses the application, the user is matched with his/her corresponding property string (e.g., based on log-in information). Upon being matched, the customization object associated with the property string is accessed, assigned to the user, and used to customize the application. Thus, the present invention provides a more flexible implementation that requires less human interaction to implement application customizations.

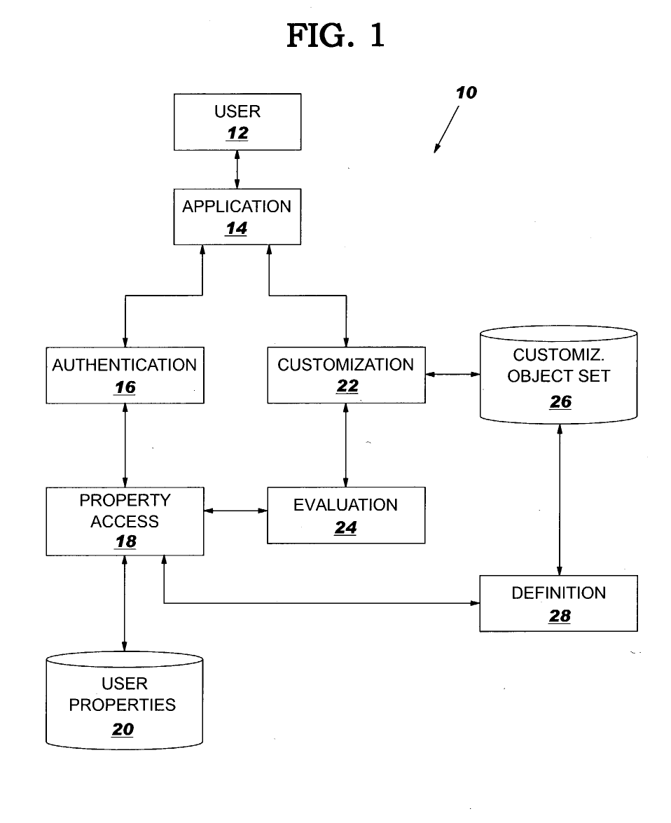

Turning to the figures, FIG. 1 depicts an illustrative embodiment of an application customization system 10. Under the present invention, user 12 accesses application 14, which includes various features that can be customized. When attempting to access application 14, authentication system 16 will first “authenticate” user 12. Under the present invention any process for authenticating user 12 now known or later developed can be implemented. For example, user 12 could provide a user name and password that is authenticated by authentication system 16. In another embodiment, using the identification of user 12, authentication system 16 could communicate with property access system 18 to obtain one or more user properties 20. User properties 20 can include a “group-specific” property or a “personal” property. For example, user properties 20 could contain the specific path/directory expression that corresponds to user 12's exact directory path and name (e.g., /EMP/HR/Jones), or it could contain an expression that corresponds to a node in the directory tree (e.g., /EMP/HR) that is the parent directory for a group of users that includes user 12. To this extent, users of a system can be defined in a hierarchical form. Only a limited number of users in the hierarchy may be granted access to application 14. Further, an anonymous user (i.e., guest user, unidentified user) may attempt to access an application 14 that requires a user identification. In either case, if user 12 does not have privilege to access application 14, application 14 can be terminated with or without providing an error message to user 12.

Once user 12 is authenticated, various traits/features of application 14 can be customized. For example, alternative user interfaces can be presented (i.e., graphical vs. textual, chart vs. spreadsheet, etc.), access to data/functionality of application 14 can be limited (read vs. read/write, employee contact information vs. employee salary information, etc.), announcements can be provided to user 12 (i.e., company-wide, group-wide, individual reminder, etc.), roles (i.e., student, faculty, administrator, etc.) and/or permissions (none, read, read/write) can be assigned to user 12, etc.

In any event, when one or more features that can be customized is encountered during execution, application 14 will “call” customization system 22 to determine the appropriate customization (if any). As shown, customization system 22 contains or has access to a set of customization objects 26. Each customization object in set 26 has an associated property string, and contains data that defines a customization of application 14 for one or more users. The appropriate customization object(s) for user 12 will be identified based on one or more user properties corresponding to user 12 and the associated property string. The property string is based on one or more user properties. Typical user properties upon which the property string can be based include, for example, a path/directory expression corresponding to a position of user(s) within a hierarchy, an attribute of user(s) (e.g., user age, country), a group or department designation for user(s), a privilege level of user(s), a display preference of user(s), etc. For example, a property string based on a path/directory expression of user 12 could be any of: “/EMP/HR/Jones”, “/EMP/*”, “/EMP/HR/*”. Under the present invention, the property string can be based on a single user property, a set of user properties, or a subset of a plurality of user properties. For example, the property string can comprise a logical expression such as “Dept=HR and Country=USA”.

As discussed above, user properties can be obtained by authentication system 16. The user properties can then be passed to customization system 22 to determine the appropriate customization. Customization system 22 calls evaluation system 24 to obtain a list of customization objects for user 12. Customization system 22 provides evaluation system 24 with the user properties for user 12 and all the possible customization objects for application 14. Evaluation system 24 matches the customization objects with user 12 based on the user properties and the property strings associated with the customization objects. Alternatively, evaluation system 24 can obtain the necessary user properties for user 12 when required.

For each customization object, evaluation system 24 determines whether the user properties of user 12 match the associated property string. For example, a personal directory of user 12 may be “/EMP/HR/Jones”. A property string for a customization object may be “/EMP/HR/*”, where the “*” indicates that anything after the specified string is valid. In this case, evaluation system 24 would determine a match, and return the customization object for user 12. More complex property strings may also be associated with a customization object. For example, a property string may be a logical expression such as “Dept=HR and Country=USA”. Further, a property string may include an expression that is derived from one or more user properties. For example, a property string may comprise “isManager” that returns a match if user 12 is a manager. To determine if user 12 is a manager, several user properties may be required.

Evaluation system 24 may call property access system 18 to obtain one or more user properties for user 12 (e.g., determine group membership). To this extent, property access system 18 typically includes a generic interface for setting and retrieving user properties 20. In general, user properties 20 is intended to represent any manner of storing user properties for one or more users. For example, user properties can be stored in a plurality of formats and/or a plurality of locations such as a system directory and a user registry. As such, an access component (not shown) for each format/location can be used to provide a generic interface to property access system 18 for reading and writing user properties. Property access system 18 also allows other systems to obtain user properties 20 without knowledge of the format/location in which a particular user property is stored. For example, user properties 20 can be communicated to/from property access system 18 as strings. Property access system 18 can perform any required format conversions between the stored value and the value communicated to/from the various systems. In another embodiment, other systems can obtain user properties 20 by accessing user properties 20 directly, without using property access system 18.

In any event, once evaluation system 24 has determined the appropriate customization object(s) for user 12, evaluation system 24 returns the customization object(s) to customization system 22. As indicated above, each customization object has an associated property string. In a typical embodiment, definition system 28 defines and stores (i.e., in set of customization objects 26) the customization objects and associated property strings. As explained above, each customization object is a collection of data that is used to determine the appropriate customization(s) of application 14 for user 12 or a group of users. This data can be stored in any format desired. For example, a customization object can include Boolean values that determine whether to turn on/off certain behaviors of application 14. Definition system 28 builds a property string by accessing user properties 20 (e.g., via property access system 18). Specifically, to build a property string, definition system 28 obtains one or more user properties 20 from property access system 18, which can provide the user properties as strings. Definition system 28 may then modify the returned user properties 20 to create a desired property string. For example, a portion of a user property may be removed and replaced with a wildcard (“*”) indicating that any value can be provided. Alternatively, definition system 28 can define property strings without accessing user properties 20. In any event, the property string serves to associate an object with one or more particular user properties.

In a typical embodiment, customization system 22 maintains the set of customization objects that evaluation system 24 determined match the user properties of user 12. Based on the data in a customization object, customization system 22 either implements the customized behavior or returns the customization object to application 14 for implementation. In the case that a plurality of matches are found, the best match is provided, as discussed further below. If no match is found, a default customization object can be provided. In any event, as will be further described below, once a customization object for user 12 is identified, it can be stored in a localized memory (e.g., a cache). This prevents the customization object from having to be re-identified and retrieved from set of customization objects 26 when user 12 accesses application 14 in the future.

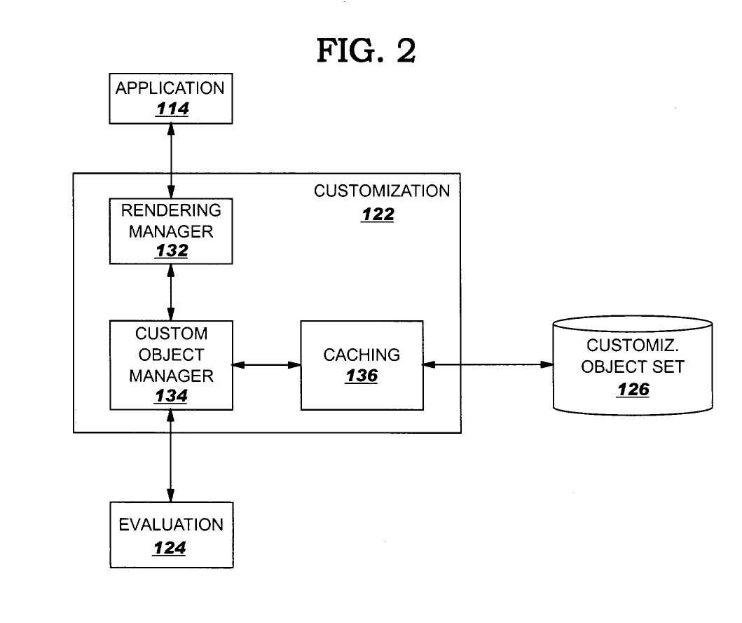

Referring now to FIG. 2, a detailed embodiment of customization system 122 is shown. As depicted, customization system 122 includes a rendering manager 132, a customization object manager 134, and a caching system 136. Upon being accessed, application 114 communicates a feature/trait to be customized to rendering manager 132. Rendering manager 132 determines which behavior customization to perform by requesting a portion of or all of a customization object from customization object manager 134.

In an initial application customization request, customization object manager 134 obtains a list of possible customization objects from caching system 136. Caching system 136 reads in all possible customization objects for application 114 from customization object set 126. Customization object manager 134 then consults evaluation system 124 to obtain one or more customization objects for the current user (as described above). After obtaining the customization objects, customization object manager 134 communicates the appropriate customization object for the application customization to rendering manager 132. Based on the data contained in the customization object, rendering manager 132 performs the appropriate customization (for example, provides an appropriate user interface) and returns to application 114. In addition, caching system 136 can cache the customization objects returned from evaluation system 124. Consequently, for future application customizations, customization object manager 134 obtains the customization object from caching system 136 without communicating with evaluation system 124. Alternatively, caching system 136 can cache the list of all possible customization objects while custom object manager 134 maintains the list of customization objects for the current user. In either case, no further communication with customization object set 126 would be required after the initial application customization. It should be appreciated that application 114 could call customization system 122 (e.g., request a customization object) when application 114 is initially accessed, or after user 12 has been authorized. In either case, any performance degradation due to obtaining customization objects would be done during application initialization, before user 12 is interacting extensively with application 14.

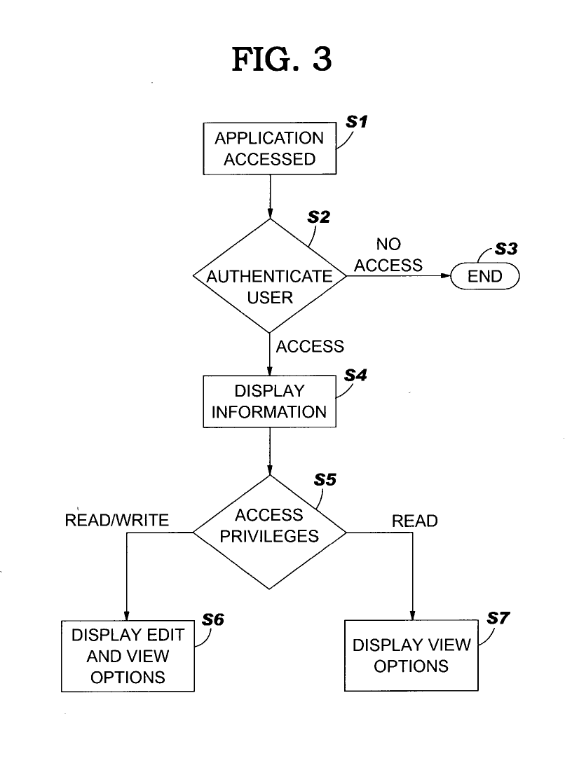

FIG. 3 depicts illustrative steps performed during execution of an application for displaying and/or modifying information. In step S1, a user accesses the application. The application authenticates the user in step S2. If the user does not have privileges to access the application, the application is terminated in step S3. Otherwise, the application displays the information in step S4. The interface for the application is customizable according to various operations that the user can perform on the information. Consequently, the privileges of the user are determined in step S5. If the user has read/write privileges, the application displays edit and view options in step S6. When the user only has read privileges, the application displays the view options in step S7. Execution of the application continues until the user terminates the application.

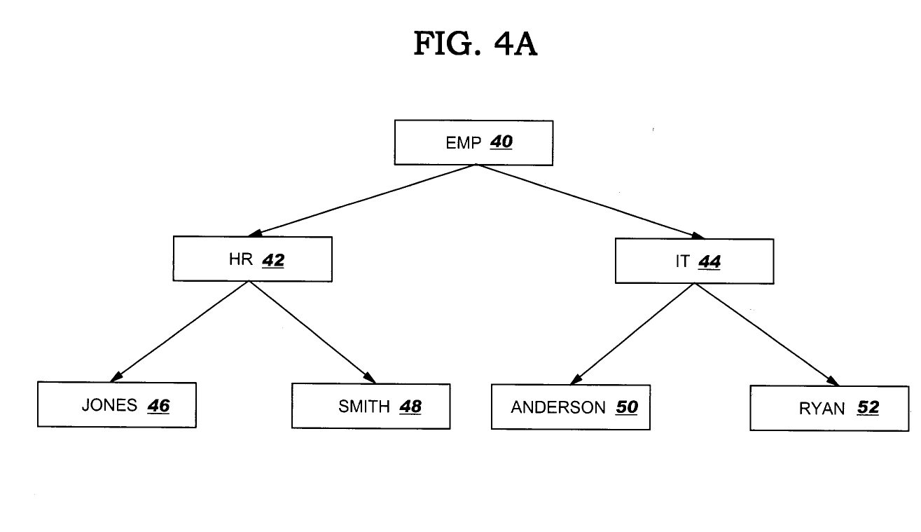

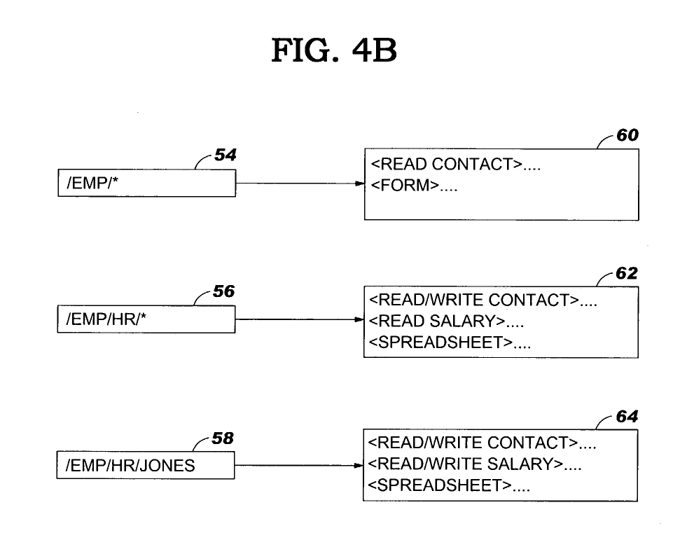

FIG. 4A depicts an illustrative embodiment of an organization of users. As indicated above, the property string can be based on any number of user properties. One such user property is the position/location of the user within a hierarchy. Thus, in the example shown in FIG. 4A, all employees are organized into a hierarchical structure (i.e., a tree) of three levels. To this extent, each user is uniquely identified by a path that consists of the successive connected nodes leading from the root of the tree to the node representing the user. Similarly, multiple users may be identified by a partial path consisting of nodes leading from the root to the parent node of a user entry. In this example, the root node is EMP 40. Two child nodes of EMP 40 are HR 42 and IT 44. Child nodes 42 and 44 can represent groups within an organization into which each employee is placed (i.e., Human Resources, Information Technology, etc.). HR 42 and IT 44 further include the personal nodes for each user (i.e., JONES 46, SMITH 48, ANDERSON 50, RYAN 52, etc.). As a result, the user named Jones is uniquely identified by the path (and a possible user property) of “/EMP/HR/JONES”, while the user named Ryan is uniquely identified by the path (and a possible user property) of “/EMP/IT/RYAN”. All users under HR 42 may also have a shared path (and a possible user property) of “/EMP/HR”. It is understood that any naming convention, number of groupings, number of users, etc. can be implemented. Those shown herein are for illustrative purposes only.

FIG. 4B depicts illustrative customization objects and property strings generated based on the organization shown in FIG. 4A. Property strings 54, 56 include a “*” as a wildcard at the end of the string to indicate that any content can follow, and a match will be provided. It is understood that any symbol, character, or system can be used to implement this functionality. Those skilled in the art will recognize that regular expressions or other methods of syntactic matching can easily be applied to the processing of property strings. Property string 58 does not include a wildcard, and therefore requires an exact match. It is further understood that matches for property strings 54, 56, 58 can be case sensitive or case insensitive.

Each property string 54, 56, 58 is associated with a customization object 60, 62, 64, respectively. When an application requires a customization object 60, 62, 64, a user property representing a path is provided and compared to property strings 54, 56, 58. For example, if Smith is the active user, a user property “/EMP/HR/SMITH” would be provided. In this case, a match occurs for both property strings 54, 56. To determine which customization object, 60 or 62, will be returned, any rule can be implemented. For example, property strings 54, 56 and/or customization objects 60, 62, 64 can be assigned a priority, the property string including the most characters can be used, a matching property string that includes no wild cards can be used, etc. A particular user can specify further customizations, or be provided with a unique customization (i.e., act as an administrator for an application). For example, customization object 64 is only returned for the Jones user.

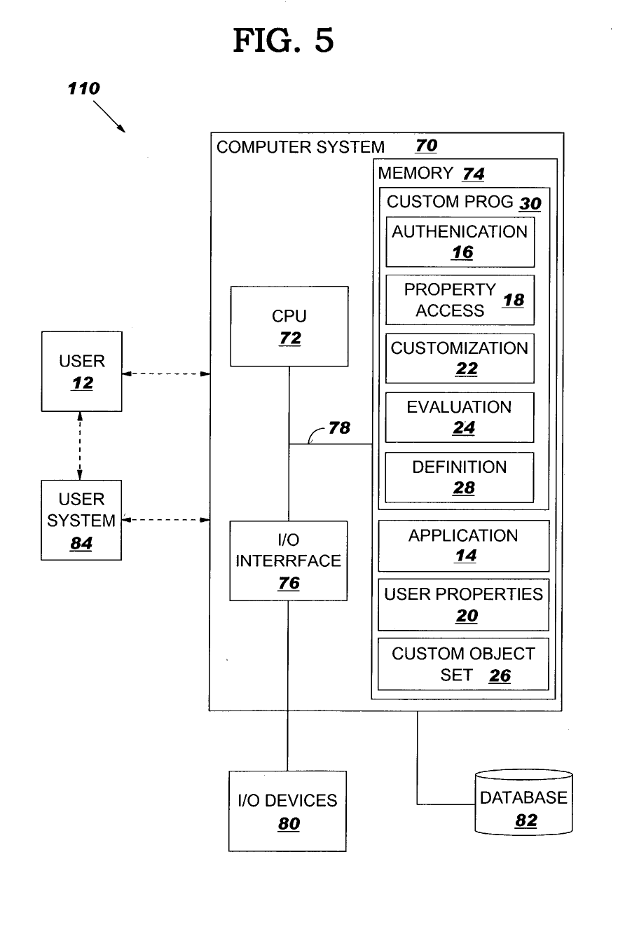

FIG. 5 depicts one embodiment of an application customization system 110 implemented in a computing environment. System 110 includes a computer system 70 that generally comprises a central processing unit (CPU) 72, memory 74, input/output (I/O) interface 76, bus 78, I/O devices 80 and database 82. User 12 communicates with computer system 70 using one or more I/O devices 80 or by communicating with user system 84 which in turn communicates with computer system 70. It is understood that although not shown, user system 84 typically contains components (e.g., CPU, memory, etc.) similar to computer system 70. Such components have not been separately depicted and described for brevity purposes. In addition, it is understood that computer system 70 and user system 84 comprise any type of device capable of accepting input, providing output, and/or communicating with another device.

User system 84 communicates with computer system 70 by interfacing with one or more I/O devices 80 of computer system 70. Communications can occur via one or more direct hardwired connections (e.g., serial port), or via an addressable connection in a client-server (or server-server) environment, which may utilize any combination of wireline and/or wireless transmission methods. In the case of the latter, the server and client may be connected via the Internet, a wide area network (WAN), a local area network (LAN), a virtual private network (VPN), or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Computer system 70 can comprise any general purpose or specific-use system utilizing standard operating system software, which is designed to drive the operation of the particular hardware and which is compatible with other system components and I/O controllers. CPU 72 may comprise a single processing unit, multiple processing units capable of parallel operation, or be distributed across one or more processing units in one or more locations, e.g., on a client and server. Memory 74 may comprise any known type of data storage and/or transmission media, including magnetic media, optical media, random access memory (RAM), read-only memory (ROM), a data cache, a data object, etc. Moreover, similar to CPU 72, memory 74 may reside at a single physical location, comprising one or more types of data storage, or be distributed across a plurality of physical systems in various forms.

I/O interface 76 may comprise any system for exchanging information with one or more I/O devices 80, including an I/O port (serial, parallel, ethernet, keyboard, mouse, etc.), an universal serial bus (USB) port, expansion bus, integrated drive electronics (IDE), etc. I/O devices 80 may comprise any known type of input/output device capable of communicating with I/O interface 76 with or without additional devices (i.e., expansion cards), including a network system, a modem, speakers, a monitor (cathode-ray tube (CRT), liquid-crystal display (LCD), etc.), hand-held device, keyboard, mouse, voice recognition system, speech output system, scanner, printer, facsimile, pager, storage devices, etc. Bus 78 provides a communication link between each of the components in computer system 70 and likewise may comprise any known type of transmission link, including electrical, optical, wireless, etc. In addition, although not shown, additional components, such as cache memory, communication systems, system software, etc., may be incorporated into computer system 70.

Database 82 may provide storage for information necessary to carry out the present invention as described above. As such, database 82 may include one or more storage devices, such as a magnetic disk drive-or an optical disk drive. Further, database 82 can include data distributed across, for example, a LAN, WAN or a storage area network (SAN) (not shown). Database 82 may also be configured in such a way that one of ordinary skill in the art may interpret it to include one or more storage devices.

Shown in memory 74 as computer program code is customization program 30, application 14, user properties 20, and customization object set 26. Customization program 30 is shown including authentication system 16, property access system 18, customization system 22, evaluation system 24, and definition system 28. Each system shown performs the same functionality as described above with reference to FIG. 1. For example, authentication system 16 will determine whether user 12 is authorized to access application 14.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, controls computer system 70 and/or user system 84 such that they carry out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another launguage, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for customizing an application, comprising:
identifying a user having a user property;
matching the user with a property string that is based on the user property,
wherein the property string is associated with a customization object;
accessing the customization object; and
customizing the application for the user based on the customization object.

2. The method of claim 1, wherein customizing the application includes at least one of: modifying a user interface for the application, providing access control for the application, providing announcements to the user and assigning system roles and permissions to the user.

3. The method of claim 1, wherein the user property comprises at least one of: a path, a group designation, and a user attribute.

4. The method of claim 1, wherein the user property is provided from at least one of: a system directory and a user registry.

5. The method of claim 1, wherein the matching step is performed when the application is accessed.

6. The method of claim 1, further comprising:
defining at least one customization object in a customization object set; and
associating the at least one customization object with a property string, wherein the customization object is matched with the user property based on the property string.

7. The method of claim 1, further comprising defining customizations for the application that are implemented based on the customization object.

8. The method of claim 1, further comprising authenticating the user when the application is accessed.

9. The method of claim 1, further comprising:
obtaining the customization object from a customization object set; and
caching the customization object for subsequent customizations.

10. A method for customizing an application comprising:
providing a property string that is based on a user property, wherein the property string is associated with a customization object;
matching a user with the property string when the application is accessed;
assigning the customization object to the user; and
customizing the application based on the customization object.

11. The method of claim 10, wherein customizing the application includes at least one of: modifying a user interface for the application, providing access control for the application, providing announcements to the user and assigning system roles and permissions to the user.

12. The method of claim 10, wherein the user property comprises at least one of: a path, a group designation, and a user attribute.

13. The method of claim 10, wherein the user property is provided from at least one of: a system directory and a user registry.

14. The method of claim 10, further comprising:
defining at least one customization object in a customization object set; and
associating the at least one customization object with a property string, wherein the customization object is matched with the user property based on the property string.

15. The method of claim 10, further comprising defining customizations for the application that are implemented based on the customization object.

16. The method of claim 10, further comprising authenticating the user when the application is accessed.

17. The method of claim 10, further comprising:
obtaining the customization object from a customization object set; and
caching the customization object for subsequent customizations.

18. A system for customizing an application, comprising:
an evaluation system for matching a user with a property string, wherein the property string is based on a user property; and
a customization system for customizing an application for the user based on a customization object associated with the property string.

19. The system of claim 18, further comprising a definition system for defining the customization object and associating the customization object with a property string, wherein the property string is used to match the user property with the customization object.

20. The system of claim 18, further comprising an authentication system for authenticating the user when the application is accessed.

21. The system of claim 18, wherein customizing the application includes at least one of: modifying a user interface for the application, limiting access to functionality of the application, providing announcements to the user, and assigning roles and permissions to the user.

22. The system of claim 18, wherein the user property comprises at least one of: a path, a group designation, and a user attribute.

23. The system of claim 18, wherein the user property is provided from at least one of: a system directory and a user registry.

24. A computer program product comprising a computer useable medium having computer readable program code embodied therein for customizing an application, the program product comprising:
program code configured to match a user with a property string, wherein the property string is based on a user property; and
program code configured to customize an application for the user based on a customization object associated with the property string.

25. The computer program product of claim 24, further comprising:
program code configured to define the customization object; and
program code configured to associate the customization object with a property string, wherein the property string is used to match the user property with the customization object.

26. The computer program product of claim 24, further comprising program code configured to authenticate the user when the application is accessed.

27. The computer program product of claim 24, further comprising program code configured to provide a property string based on a user property.

28. The computer program product of claim 27, wherein the user property comprises at least one of: a path, a group designation, and a user attribute.
